(19) United States
(12) Patent Application Publication
(10) Pub. No.: US 2006/0146675 A1
(43) Pub. Date: Jul. 6, 2006

(54) Methods, systems and computer program products for recording data on and/or reproducing data from an optical disk

(76) Inventor: Jeong-ho Shin, Gyeonggi-do (KR)

Correspondence Address: MYERS BIGEL SIBLEY & SAJOVEC, PO BOX 37428, RALEIGH, NC, 27627, US

(21) Appl. No.: 11/313,580

(22) Filed: Dec. 21, 2005

(30) Foreign Application Priority Data
Dec. 30, 2004 (KR) 10-2004-0116996

(51) Int. Cl. G11B 5/09

(52) U.S. Cl. 369/53.17; 369/53.15; 369/47.14

(57) ABSTRACT

Systems for recording data on and/or reproducing data from an optical disk are provided. The system includes a microcontroller unit (MCU) and a defect detector, electrically coupled to the MCU. The defect detector is configured to determine whether a data block is a defect block using a radio frequency (RF) signal generated when encoded write data is recorded in the data block and read Absolute Time In Pre-groove (ATIP) information which specifies the position of the defect block if it is determined that the data block is a defect block. The system further includes a storage unit electrically coupled to the defect detector. The storage unit is configured to store the ATIP information as defect position information and transmit the defect position information to the MCU. The MCU is further configured to control recordation of data, which is to be recorded in the defect block, in a spare area of an optical disk. The spare area is indicated in reassignment position information corresponding to the defect position information. Related methods and computer program products are also provided.

### CLAIM OF PRIORITY

This application is related to and claims priority from Korean Patent Application No. 10-2004-0116996 filed on Dec. 30, 2004, the disclosure of which is hereby incorporated herein by reference as if set forth in its entirety.

### FIELD OF THE INVENTION—CHANGE

The present invention relates to optical disks and, more particularly, to methods, systems and computer program products for using optical disks for storing defect position information.

### BACKGROUND OF THE INVENTION

In general, an optical disk recording/reproducing system records audio and/or video data on a rewritable optical disk or reproduces audio and/or video data from the rewritable optical disk, such as a Compact Disk-Rewritable (CD-RW), a CD-Mount Rainier rewritable (MRW) and a Digital Versatile Disk (DVD)+MRW.

When the rewritable optical disk is repeatedly used, the disk may deteriorate, causing a defect to occur therein. Furthermore, a defect may occur in the optical disk due to, for example, a scratch or a fingerprint. The defect may occur in a lead-in area, a program area, or a lead-out area of an optical disk as illustrated in FIG. 1.

Referring to FIG. 1, the structure of a conventional rewritable optical disk will be discussed. As illustrated in FIG. 1, each track of the optical disk includes a lead-in area, a program area and a lead-out area. The lead-in area typically includes information regarding a starting point of the optical disk and information regarding defect management recorded thereon. The program area typically includes audio or video data recorded thereon. The lead-out area typically includes information regarding an ending point of the optical disk recorded thereon.

As further illustrated in FIG. 1, the program area includes data areas and spare areas that replace defect blocks (or data sectors) that may be caused when data is recorded on the optical disk. Each data area may include a plurality of data blocks (or data sectors) BL1 through BLn, where n is a natural number, for example, an integer like the number 39.

Operations of a conventional optical disk recording/reproducing system that records data on or reproduces data from a track of the optical disk illustrated in FIG. 1 will now be discussed. The system includes an optical pickup that records encoded data on the optical disk or extracts a Radio Frequency (RF) signal from write data recorded on the optical disk, an encoder that transmits the encoded data to the optical pickup, a decoder that reproduces the data from the optical disk by decoding the RF signal output from the optical pickup, a defect detector that detects a defect block using the RF signal and reads position information regarding the defect block, a Microcontroller Unit (MCU), a Read Only Memory (ROM), and a Random Access Memory (RAM). The MCU controls the optical pickup, the encoder, and the decoder to perform a read/write operation of the system, and controls the read/write operation using firmware stored in the ROM. The firmware is a program used to control overall operations of the system.

During the write operation a formatting operation is performed. The optical pickup detects an RF signal from the optical disk while recording data on a data block of the optical disk. The defect detector determines whether the data block is a defect block (or a defect sector) using the RF signal. If the data block, for example, a data block BL9 illustrated in FIG. 1, is defective, Absolute Time In Pre-groove (ATIP) information is read to detect the position of the data block. The MCU stores the ATIP information in the RAM. While the MCU is storing the ATIP information in the RAM, the optical pickup keeps recording data on the data blocks.

After the optical pickup completes data recording, the MCU determines a reassignment position (or address) for the defect block in a spare area of the optical disk. The spare area may not already include a defect block. Data to be recorded on the defect block is recorded in a spare area indicated by the reassignment position information. After recording the data in the spare area, defect position information and the reassignment position information are recorded in the lead-in area of the optical disk.

During the read operation, the optical pickup reads the defect position information and the reassignment position information from the lead-in area. When a defect block is detected during the read operation, the optical pickup moves to a data block indicated in the reassignment position information, reads data from the data block, returns to the defect block, and continues reading data from the defect block.

However, in the conventional optical disk recording/reproducing system, when the MCU performs an interrupt operation while storing ATIP information in the RAM using firmware, the ATIP information may be incompletely recorded in the RAM. For example, when the data blocks BL9 and BL10 are defect blocks and the MCU performs an interrupt operation to record defect position information regarding the defect block BL10 on the RAM while storing the ATIP information, the defect position information regarding only the defect block BL10 is likely to be stored in the RAM. Accordingly, the optical disk recording/reproducing system may malfunction during the read operation of the optical pickup.

### SUMMARY OF THE INVENTION

Some embodiments of the present invention provide systems for recording data on and/or reproducing data from an optical disk. The system includes a microcontroller unit (MCU) and a defect detector, electrically coupled to the MCU. The defect detector is configured to determine whether a data block is a defect block using a radio frequency (RF) signal generated when encoded write data is recorded in the data block and read Absolute Time In Pre-groove (ATIP) information which specifies the position of the defect block if it is determined that the data block is a defect block. The system further includes a storage unit electrically coupled to the defect detector. The storage unit is configured to store the ATIP information as defect position information and transmit the defect position information to the MCU. The MCU is further configured to control recordation of data, which is to be recorded in the defect block, in a spare area of an optical disk. The spare area is indicated in reassignment position information corresponding to the defect position information.

In further embodiments of the present invention, the system may further include an encoder and an optical pickup. The encoder is electrically coupled to the MCU and may be configured to encode write data received from the microcontroller unit to provide the encoded write data. The optical pickup is electrically coupled to the encoder and may be configured to record the encoded write data in a data block of a data area of the optical disk.

In still further embodiments of the present invention, the system may further include a decoder. The decoder is electrically coupled to the optical disk and may be configured to decode a radio frequency signal output from the optical disk and output the decoded radio frequency signal to the MCU. The optical disk may be configured to store the defect position information and the reassignment position information or not to store the defect position information.

In some embodiments of the present invention, the spare area of the optical disk may not include a defect block. The optical disk may include a compact disk (CD)-Mount Rainier reWritable (MRW) and/or a Digital Versatile Disk (DVD)+MRW.

Although system aspects of the present invention are primarily discussed above, embodiments of the present invention also provide method and computer program product aspects.

### BRIEF DESCRIPTION OF THE DRAWINGS

FIG. 1 is a diagram illustrating the structure of a conventional rewritable optical disk.

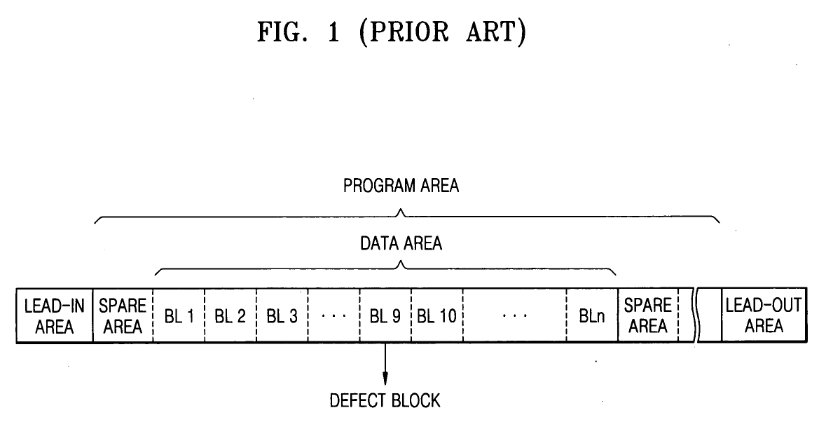

FIG. 2 is a block diagram illustrating an optical disk recording/reproducing system according to some embodiments of the present invention.

FIG. 3 is a flowchart illustrating operations of recording data on and/or reproducing data from an optical disk recording/reproducing system according to some embodiments of the present invention.

### DETAILED DESCRIPTION OF EMBODIMENTS OF THE PRESENT INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or in a visually oriented programming environment, such as VisualBasic.

The invention is described in part below with reference to flowchart illustrations and/or block diagrams of methods, systems and computer program products according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

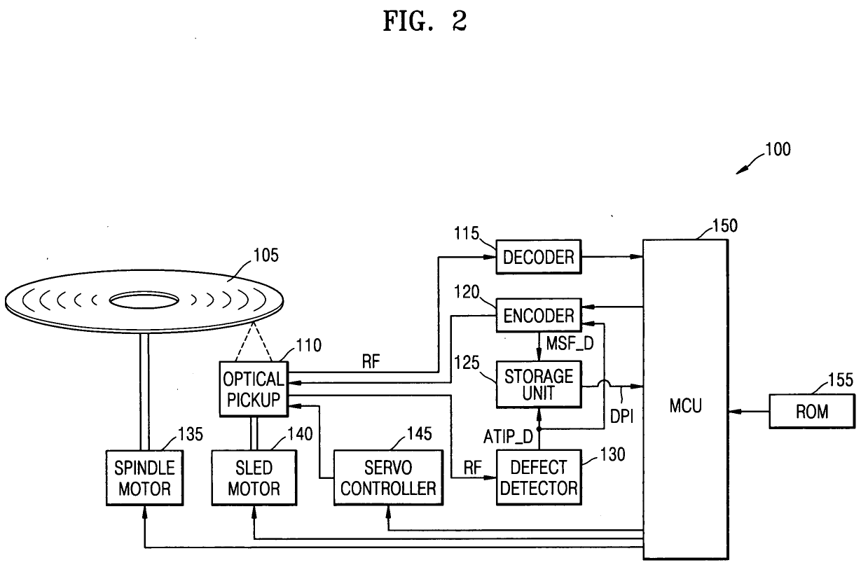

Referring now to FIG. 2, a block diagram of an optical disk recording/reproducing system 100 according to some embodiments of the present invention will be discussed. The optical disk recording/reproducing system 100 includes an optical disk 105, an optical pickup 110, a decoder 115, an encoder 120, a storage unit 125, a defect detector 130, a spindle motor 135, a sled motor 140, a servo controller 145, a microcontroller unit (MCU) 150, and a read only memory (ROM) 155.

The optical disk 105 may be a Compact Disk-Rewritable (CD-RW) or a Digital Versatile Disk (DVD)+MRW. Tracks of the optical disk 105 may include a lead-in area, a program area, and a lead-out area. The lead-in area stores information regarding a starting point of the optical disk 105 and defect management information, such as defect position information and reassignment position information corresponding to the defect position information. The program area stores audio and/or video data. The lead-out area stores information regarding an ending point of the optical disk 105. The program area includes data areas and spare areas that replace defect blocks that may be caused when data is recorded on the optical disk 105. Data areas include a plurality of data blocks. The number of the data blocks may be, for example, 39.

Under control of the servo controller 145, the optical pickup 110 records encoded data on the optical disk 105, or reads data from the optical disk 105 and generates a radio frequency (RF) signal. The encoder 120 encodes write data transmitted from the MCU 150 and outputs the encoded data to the optical pickup 110. In some embodiments of the present invention, the encoder 120 may generate Minute/Second/Frame (MSF) information that is time information of the optical disk 105, using ATIP information indicating the position of a defect block.

The decoder 115 reproduces the write data by decoding an RF signal output from the optical disk 105 and outputs it to the MCU 150. In the optical disk 105, the defect position information and the corresponding reassignment position information may or may not be stored by the optical pickup 110.

The defect detector 130 is configured to determine whether a data block is a defect block using the RF signal generated when optical pickup 110 records the write data on the optical disk 105, and read ATIP information ATIP_D indicating the position of the defect block when the data block is determined to be a defect block. When the value of an RF signal output from a data block is less than a predetermined threshold, the data block may be a defect block.

The storage unit 125 may include a register and may store defect position information DPI and provide the defect position information DPI to the MCU 150. The defect position information DPI may be the ATIP information ATIP_D that is time information of the optical disk 105, or MSF information MSF_D produced by the encoder 120 using the ATIP information ATIP_D. The ATIP information ATIP_D is a physical address of a data block of the optical disk 105, which indicates the position of the data block.

During a read/write operation of the system 100, the spindle motor 135 rotates the optical disk 105 and the sled motor 140 moves the optical pickup 110 to the optical disk 105 in a radial direction. During the read/write operation of the system 100, the servo controller 145 drives a tracking actuator (not shown) and a focusing actuator (not shown) of the optical pickup 110.

The MCU 150 is configured to control the read/write operation of the system 100 by controlling the spindle motor 135, the sled motor 140, and the servo controller 145 using firmware which is a program stored in, for example, the ROM 155. The MCU 150 is also configured to transmit the write data to a host computer (not shown) via an interface unit (not shown), or transmit the write data, which is received from the host computer via the interface unit, to the encoder 120.

Write operations of the system 100 according to some embodiments of the present invention will now be described. The write operation is performed by the encoder 120 and the optical pickup 110 of the system 100. The write operation includes a formatting operation. The optical pickup 110 detects an RF signal output from the optical disk 105 when encoded data is recorded on a data block of the optical disk 105. The defect detector 130 determines whether the data block is a defect block using the RF signal, and reads ATIP information ATIP_D which includes defect position information DPI when the data block is determined to be a defect block. The storage unit 125 stores the ATIP information ATIP_D or MSF information MSF_D, which is produced by the encoder 120 using the ATIP information ATIP_D, as the defect position information DPI. The defect position information DPI is transmitted to the MCU 150 for the write operation of the system 100. During the write operation, the optical pickup 110 continuously records data on the data block. Thus, because the system 100 is capable of immediately storing the defect position information DPI in the storage unit 125, the MCU 150 can use the defect position information DPI in performing the write operation of the system 100 after performing an interrupt operation. Accordingly, the system 100 may not malfunction during the write operation.

After the optical pickup 110 is configured to record data on the data block, the MCU 150 is configured to determine the reassignment position of the defect block in a spare area of the optical disk 105, which does not include a defect block. Data to be recorded on the defect block is recorded on the spare area of the optical disk 105, which is indicated in reassignment position information. The defect position information DPI and the reassignment position information are recorded on a lead-in area of the optical disk 105.

Read operations of the system 100 according to some embodiments of the present invention will now be described. The read operation is performed by the optical pickup 110 and the decoder 115 of the system 100. The optical pickup 110 is configured to read the defect position information DPI and the corresponding reassignment position information from the lead-in area. During a read operation, the optical pickup 110 is configured to move to a data block indicated by the reassignment position information, reads data from the data block, and moves to and reads data from a data block following the defect block.

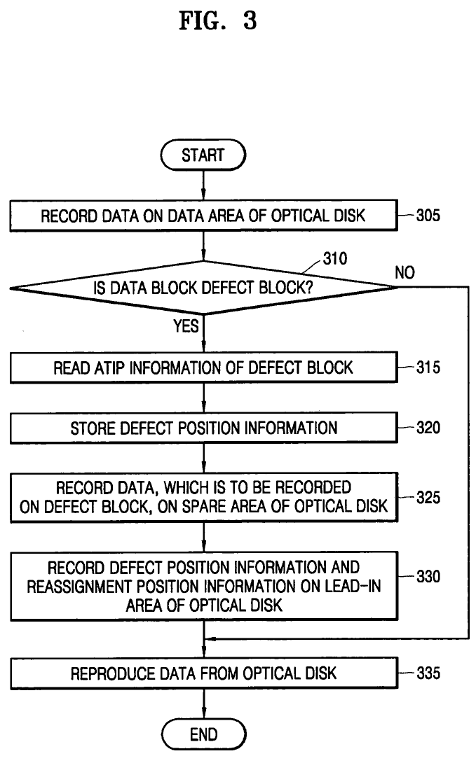

Referring now to FIG. 3, a flowchart illustrating operations of recording data on and/or reproducing data from an optical disk according to some embodiments of the present invention will be discussed. Operations of the system 100 according to some embodiments of the present invention will now be discussed with respect to FIGS. 2 and 3.

Operations begin at block 305 by receiving write data at the optical pickup 110 from the encoder 120 and recording the write data in a data block of a data area of the optical disk 105. In some embodiments of the present invention, the optical disk 105 may be, for example, a CD-MRW or a DVD+MRW. The defect detector 130 determines whether the data block is a defect block using an RF signal generated when the optical pickup 110 records the write data on the data block (block 310).

It is determined if the data block is a defect block (block 310). If it is determined that the data block is not a defect block (block 310), read operations are performed (block 335). If, on the other hand, it is determined that the data block is a defect block (block 310), ATIP information of the defect block is read (block 315). In some embodiments of the present invention, the defect detector 130 may be configured to read ATIP information ATIP_D, which specifies the position of the defect block (block 315).

The storage unit 125 is configured to store the ATIP information ATIP_D and/or MSF information MSF_D which is produced by the encoder 120 using the ATIP information ATIP_D as defect position information DPI (block 320). The optical pickup 110 is configured to receive reassignment position information corresponding to the defect position information DPI from the storage unit 125, and record data, which is to be recorded on the defect block, in a spare area of the optical disk 105, which is defined in the reassignment position information (block 325). The spare area of the optical disk 105 used to store the defect block does not already include a defect block.

The optical pickup 110 is configured to record the defect position information DPI and the reassignment position information on a lead-in area of the optical disk 105 (block 330). The decoder 115 is configured to reproduce the write data by decoding an RF signal output from the optical pickup 110 (block 335), which includes the defect position information DPI and the corresponding reassignment position information or does not include the defect position information DPI.

It will be understood that although certain operations are discussed above as being performed by particular elements of the system, embodiments of the present invention are not limited to the examples provided herein. Operations according to embodiments of the present invention may be carried out by various systems without departing form the scope of the present invention.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A system for recording data on and/or reproducing data from an optical disk, comprising:
a microcontroller unit (MCU);
a defect detector, electrically coupled to the MCU, configured to determine whether a data block is a defect block using a radio frequency (RF) signal generated when encoded write data is recorded in the data block and read Absolute Time In Pre-groove (ATIP) information which specifies the position of the defect block if it is determined that the data block is a defect block; and
a storage unit, electrically coupled to the defect detector, configured to store the ATIP information as defect position information and transmit the defect position information to the MCU, the MCU being further configured to control recordation of data, which is to be recorded in the defect block, in a spare area of the optical disk, the spare area being indicated in reassignment position information corresponding to the defect position information.

2. The system of claim 1, further comprising:
an encoder, electrically coupled to the MCU, configured to encode write data received from the microcontroller unit to provide the encoded write data; and
an optical pickup, electrically coupled to the encoder, configured to record the encoded write data in a data block of a data area of the optical disk.

3. The system of claim 2, further comprising a decoder, electrically coupled to the optical disk, configured to decode a radio frequency signal output from the optical disk and output the decoded radio frequency signal to the MCU, wherein the optical disk is configured to store the defect position information and the reassignment position information, or is configured not to store the defect position information.

4. The system of claim 3, wherein the spare area of the optical disk does not include a defect block.

5. The system of claim 2, wherein the optical disk comprises a compact disk (CD)-Mount Rainier reWritable (MRW) and/or a Digital Versatile Disk (DVD)+MRW.

6. A system for recording data on and/or reproducing data from an optical disk, comprising:
a microcontroller unit (MCU);
an encoder, electrically coupled to the MCU, configured to encode write data received from the MCU;
a defect detector, electrically coupled to the MCU, configured to determine whether a data block is a defect block using a radio frequency signal generated when the encoded write data is recorded in the data block and read Absolute Time In Pre-groove (ATIP) information, which indicates the position of the defect block, if it is determined that the data block is a defect block; and
a storage unit, electrically coupled to the defect detector, configured to store minute/second/frame (MSF) information, which is produced by the encoder using the ATIP information as defect position information, and to transmit the defect position information to the MCU, the MCU is further configured to control an optical pickup to record data, which is to be recorded in the defect block, in a spare area of the optical disk, the spare area being indicated in reassignment position information corresponding to the defect position information.

7. The system of claim 6, further comprising the optical pickup, electrically coupled to the encoder, configured to record the encoded write data in a data block of a data area of an optical disk;

8. The system of claim 7, further comprising a decoder, electrically coupled to the optical pickup, configured to decode a radio frequency signal output from the optical disk, and output the decoded radio frequency signal to the MCU, wherein the optical disk is configured to store the defect position information and the reassignment position information or configured not to store the defect position information.

9. The system of claim 8, wherein the spare area of the optical disk does not include a defect block.

10. The system of claim 8, wherein the optical disk comprises a compact disk (CD)-Mount Rainier reWritable (MRW) and/or a Digital Versatile Disk (DVD)+MRW.

11. A method of recording data on and/or reproducing data from an optical disk, comprising:
recording data in a data block of a data area of the optical disk;
determining if the data block is a defect block using a radio frequency (RF) signal generated when write data is recorded on the data block;
reading Absolute Time In Pre-groove (ATIP) information which indicates the position of the defect block if it is determined that the data block is not a defect block;
storing the ATIP information as defect position information;
recording data, which is to be recorded in the defect block, in a spare area of the optical disk indicated by reassignment position information corresponding to the defect position information;
recording the defect position information and the reassignment position information in the optical disk; and
reproducing the write data by decoding a radio frequency signal output from the optical disk if it is determined that the data is a defect block, the optical disk storing the defect position information and the reassignment position information or not storing the defect position information.

12. The method of claim 11, wherein the spare area of the optical disk does not include a defect block and wherein recording the defect position information and the reassignment information comprises recording the defect position information and the reassignment information in a lead-in area of the optical disk.

13. The method of claim 11, wherein the optical disk is one of a compact disk (CD)-Mount Rainier reWritable (MRW) and a Digital Versatile Disk (DVD)+MRW.

14. A method of recording data on and/or reproducing data from an optical disk, comprising:
recording data in a data block of a data area of the optical disk;
determining if the data block is a defect block using a radio frequency signal generated when write data is recorded in the data block;
reading Absolute Time In Pre-groove (ATIP) information which indicates the position of the defect block if it is determined that the data block is a defect block;
storing minute/second/frame (MSF) information, which is obtained by an encoder of an optical disk recording/reproducing system using the ATIP information, as defect position information;
recording data, which is to be recorded in the defect block, in a spare area of the optical disk indicated by reassignment position information corresponding to the defect position information;
recording the defect position information and the reassignment position information in the optical disk; and
reproducing the write data by decoding a radio frequency signal output from the optical disk if the data block is determined not to be a defect block, the optical disk stores the defect position information and the reassignment position information or does not store the defect position information.

15. The method of claim 14, wherein the spare area of the optical disk does not include a defect block and wherein recording the defect position information and the reassignment position information comprises recording the defect position information and the reassignment information in a lead-in area of the optical disk.

16. The method of claim 14, wherein the optical disk is one of a compact disk (CD)-Mount Rainier reWritable (MRW) and a Digital Versatile Disk (DVD)+MRW.

17. A computer program product for recording data on and/or reproducing data from an optical disk, comprising:
computer readable storage medium having computer readable program code embodied in said medium, the computer readable program code comprising:
computer readable program code configured to record data in a data block of a data area of the optical disk;
computer readable program code configured to determine if the data block is a defect block using a radio frequency (RF) signal generated when write data is recorded on the data block;
computer readable program code configured to read Absolute Time In Pre-groove (ATIP) information which indicates the position of the defect block if it is determined that the data block is a defect block;
computer readable program code configured to store the ATIP information as defect position information;
computer readable program code configured to record data, which is to be recorded in the defect block, in a spare area of the optical disk indicated by reassignment position information corresponding to the defect position information;
computer readable program code configured to record the defect position information and the reassignment position information in the optical disk; and
computer readable program code configured to reproduce the write data by decoding a radio frequency signal output from the optical disk if it is determined that the data is not a defect block, the optical disk storing the defect position information and the reassignment position information or not storing the defect position information.

18. The computer program product of claim 17, wherein the spare area of the optical disk does not include a defect block and wherein the computer readable program code configured to record the defect position information and the reassignment information comprises computer readable program code configured to record the defect position information and the reassignment information in a lead-in area of the optical disk.

19. A computer program product for recording data on and/or reproducing data from an optical disk, comprising:
computer readable storage medium having computer readable program code embodied in said medium, the computer readable program code comprising:
computer readable program code configured to record data in a data block of a data area of the optical disk;
computer readable program code configured to determine if the data block is a defect block using a radio frequency signal generated when write data is recorded in the data block;
computer readable program code configured to read Absolute Time In Pre-groove (ATIP) information which indicates the position of the defect block if it is determined that the data block is a defect block;
computer readable program code configured to store minute/second/frame (MSF) information, which is obtained by an encoder of an optical disk recording/reproducing system using the ATIP information, as defect position information;
computer readable program code configured to record data, which is to be recorded in the defect block, in a spare area of the optical disk indicated by reassignment position information corresponding to the defect position information;
computer readable program code configured to record the defect position information and the reassignment position information in the optical disk; and
computer readable program code configured to reproduce the write data by decoding a radio frequency signal output from the optical disk if the data block is determined not to be a defect block, the optical disk stores the defect position information and the reassignment position information or does not store the defect position information.

20. The computer program product of claim 19, wherein the spare area of the optical disk does not include a defect block and wherein the computer readable program code configured to record the defect position information and the reassignment position information comprises computer readable program code configured to record the defect position information and the reassignment information in a lead-in area of the optical disk.
